(19) United States
(12) Patent Application Publication
(10) Pub. No.: US 2026/0194221 A1
(43) Pub. Date: Jul. 9, 2026

(54) LUMINAIRE HEAD ASSEMBLY

(71) Applicant: SCHREDER S.A., BRUXELLES (BE)

(72) Inventors: Morgan Vyvey, Liege (BE); Paul Smets, Liege (BE)

(21) Appl. No.: 19/132,094

(22) PCT Filed: Nov. 17, 2023
(86) PCT No.: PCT/EP2023/082276

§ 371 Date: May 22, 2025

(30) Foreign Application Priority Data
Nov. 24, 2022 (NL) 2033610
Dec. 12, 2022 (NL) 2033710

(51) Int. Cl. F21V 29/76

(52) U.S. Cl. CPC F21V 29/763

(57) ABSTRACT

Luminaire head assembly comprising: a frame structure with a heat sink, an optical block with at least one light source, said optical block being attached to said frame structure opposite the heat sink, a gear tray comprising one or more electrical components such as a driver configured for driving said at least one light source and/or surge protection circuitry and/or a fuse, a cover structure configured and arranged for covering at least a portion of the frame structure, said frame structure comprising a frame part with a frame opening extending between an upper and a lower side of the frame structure and configured to receive the gear tray.

### CROSS-REFERENCE TO RELATED APPLICATIONS

This application is the U.S. National Phase of International Patent Application No. PCT/EP2023/082276 filed Nov. 17, 2023, which claims priority to Netherlands Patent Application No. 2033610 filed Nov. 24, 2022, and Netherlands Patent Application No. 2033710 filed Dec. 21, 2022; the disclosures of each of which are incorporated by reference in their entirety herein.

### FIELD OF INVENTION

The field of the invention relates to a luminaire head assembly comprising a frame structure, an optical block and a cover structure, and in particular a modular luminaire head assembly for outdoor luminaires.

### BACKGROUND

Luminaires, in particular outdoor luminaires, are often designed for a particular purpose and/or for a specific customer, and many different luminaires have to be kept in stock for different applications.

In the commonly used outdoor luminaires, a luminaire head is usually manufactured, e.g. molded, as a single piece. Alternatively, if the luminaire head is manufactured by assembling different parts, the parts are often inconvenient to unmount from each other for the purpose of maintenance or replacement and/or the parts do not allow a high flexibility in terms of number, type, position and dimensions of internal components to be arranged in the luminaire head. Indeed, often luminaire heads are designed with a particular design which is fixed, or which can only be changed to a limited extent.

Therefore, conventional luminaire heads lack modularity, or have limited modularity. Hence, it is necessary to manufacture luminaire heads for different applications, thereby increasing the manufacturing costs. In addition, a large number of components are needed to address the needs of different customers, with a lot of different components requiring different molds.

The current problem occurring in the industry of outdoor luminaires is that when it is desirable to change the look of a luminaire head, often a metal housing part needs to be changed which is costly.

Also, when a different type of fixation is needed, often the housing needs to be changed. Further, typically the housing needs to function as a heat sink, requiring the housing to be made of a metal material.

In view of the above, the housing of a typical luminaire needs to fulfill at the same time a number of technical requirements (robustness, e.g., good vibration and thermal characteristics) as well as esthetical requirements. This typically result in a relatively heavy metal housing in which the various components of the luminaire are accommodated.

### SUMMARY

The object of embodiments of the invention is to provide a modular luminaire head assembly which can fulfill the required robustness and/or vibration and/or thermal characteristics in an improved manner.

According to a first aspect, there is provided a luminaire head assembly comprising a frame structure, an optical block, a gear tray and a cover structure. The frame structure has a heat sink. The optical block has at least one light source and is attached to the frame structure opposite the heat sink. The gear tray comprises one or more electrical components such as a driver configured for driving the at least one light source and/or surge protection circuitry and/or a fuse. The cover structure is configured and arranged for covering at least a portion of the frame structure. The frame structure comprises a frame part with a frame opening extending between an upper and a lower side of the frame structure and configured to receive the gear tray.

By providing on the one hand a frame structure and on the other hand a cover structure a modular assembly is obtained, allowing to optimize the frame structure for being sufficiently rigid and robust against vibrations whilst at the same time limiting the amount of material of the frame structure. Indeed, the frame structure can be given an improved shape so as to provide the required technical functionalities in an improved way, whilst the cover structure can be easily adapted according to the wishes of the customer and can be made in any material, without having to modify the frame structure of the luminaire head. Compared to prior art embodiments where often the housing fulfills the function of frame and cover at the same time, the assembly of embodiments of the invention can have a frame structure with a weight and/or volume which is smaller than the weight and/or volume of typical prior art housings whilst ensuring the same or even improved robustness and/or vibration characteristics (moment of inertia) and/or thermal characteristics and whilst allowing to use different materials and shapes for the cover structure so that the external view of the luminaire can be customized.

Further, by providing a frame structure, a cover structure and a gear tray which can be easily mounted in the frame structure a modular assembly allowing for easy maintenance is obtained. Indeed, when access to the gear tray is desirable, the cover structure or a portion thereof may be removed to access the gear tray, and because of the frame opening, the access can be either from above or from below the frame opening.

Preferably, the gear tray comprises a plate-like element on which the one or more electrical components are arranged. In this way the components can be easily replaced and/or new components may be added.

Preferably, the cover structure comprises an upper cover and a lower cover configured for covering the frame opening from above and from below, respectively. In this way, to get access to the gear tray, an operator may either remove the lower cover or the upper cover, e.g. depending in what is most convenient.

Preferably, an upper seal is arranged between the upper cover and the frame structure around the frame opening, and a lower seal is arranged between the lower cover and the frame structure around the frame opening. This results in a sealed compartment delimited by the upper cover, the lower cover, and a portion of the frame structure delimiting the frame opening.

Preferably, the upper cover adjoins the lower cover along at least two opposite sides of the luminaire head.

Preferably, the upper cover has a width which is larger than a width of the frame structure covered by the upper cover and which is arranged and dimensioned such that a portion of the heat sink is not covered by the upper cover and such that air is allowed to flow freely adjacent the heat sink.

Preferably, the frame structure has a fixation end configured to be fixed to a base, and the frame opening is located between the fixation end and the optical block. Preferable, the fixation end is an integral part of the frame structure.

Preferably, the frame structure comprises a first and second wing extending from the fixation end at a first and second longitudinal side of the frame opening. In this way, the frame structure can be given good robustness. Indeed, such structure can provide an improved moment of inertia and require less material than plate-like frame structures of the prior art.

Preferably, the first and second wing have a minimum height Hmin and a minimum thickness t, wherein 5<Hmin/t<60, preferably 6<Hmin/t<40, more preferably 7<Hmin/t<35. The inventors have discovered that such relatively thin and heigh profiles can provide the required robustness and can provide in particular improved vibration characteristics with less material as compared to prior art structures where a plate-like element is used for the frame structure. The minimum height may be e.g. between 15 mm and 60 mm and the thickness t may be between 1.5 mm and 4 mm.

In an exemplary embodiment, the first and second wing have an average height Hav and an average thickness tav, seen along a side adjacent the frame opening, wherein 5<Hav/tav<60, preferably 6<Hav/tav<40, more preferably 7<Hav/tav<35. The average height may be e.g. between 30 mm and 60 mm and the average thickness tav may be between 1.5 mm and 4 mm.

It is noted that in some embodiments the height may be constant across the entire length of the wing, whilst in other embodiments the height may vary, e.g., increase in the direction of the fixation end. Also, in some embodiments the thickness may be constant across the entire length of the wing, whilst in other embodiments the thickness may vary.

In an exemplary embodiment, the frame part delimiting the frame opening may comprise a peripheral wall delimiting the frame opening. Optionally, an inner side of the peripheral wall may be provided with fixation means facilitating the mounting of the gear tray in the frame opening. Such peripheral wall may have a maximum height which is larger than 20 mm, preferably larger than 30 mm, more preferably larger than 40 mm. In this way, the frame part is sufficiently rigid and provides enough room for the gear tray. Also, the relatively large height results in an improved moment of inertia.

Optionally, the frame structure may be a single piece with the heat sink being an integral part of the frame structure.

Preferably, the frame structure has a weight per unit width which, when looking from a fixation end configured to fix the frame to a base to a free end including the heat sink, first decreases at the level of the frame opening and then increases again at the level of the heat sink. In this way the weight is spatially distributed in an improved manner compared to prior art embodiments.

In another preferred embodiment, the frame structure comprises a second frame part wherein the heat sink is integrated in or coupled to the second frame part. In preferred embodiment, the second frame part is removably attached to the frame part with the frame opening.

Preferably, the cover structure is dimensioned such that air is allowed to flow freely adjacent the heat sink. For example, the cover structure may comprise an upper cover with a hole dimensioned such that a portion of the heat sink is accessible through said hole and such that air is allowed to flow freely adjacent the heat sink. In another exemplary embodiment, the cover structure may comprise an upper cover which does not cover the heat sink.

Preferably, the frame structure comprises metal, more preferably an aluminum material. The frame structure may be made entirely out of metal or may be partially in metal, e.g. an over-molded metal structure. The frame structure may also comprise carbon or a plastic thermos-conductor. In another example, the heatsink could be made in metal and the rest of the frame structure in a non-metal material.

Preferably, the cover structure comprises a non-metal material, more preferably a plastic material, e.g. a recycled plastic material. However, the cover may also be made of other materials such as wood or a composite material. Also, the cover structure could be a light metal cover structure, i.e. a thin metal structure could be used for example.

According to a further aspect the luminaire head assembly comprises a frame structure, an optical block and a cover structure. The frame structure has a heat sink. The optical block is provided with at least one light source and is attached to said frame structure opposite the heat sink. The cover structure is configured and arranged for covering at least a portion of the frame structure. The cover structure comprises an upper cover with a hole dimensioned such that a portion of the heat sink is accessible through said hole and such that air is allowed to flow freely adjacent the heat sink.

By providing on the one hand a frame structure and on the other hand a cover structure a modular assembly is obtained. Indeed, the cover structure can be easily adapted according to the wishes of the customer and can be made in any material, without having to modify the frame structure of the luminaire head. Moreover, by using an upper cover with a hole, the frame structure can be adequately covered whilst still allowing a good operation of the heat sink.

According to another aspect the luminaire head assembly comprises a frame structure, an optical block and a cover structure. The frame structure has a heat sink. The optical block is provided with at least one light source and is attached to said frame structure opposite the heat sink. The cover structure is configured and arranged for covering at least a portion of the frame structure. The cover structure comprises an upper cover with a width which is larger than a width of the frame structure covered by the upper cover and which is arranged and dimensioned such that a portion of the heat sink is not covered by the upper cover and such that air is allowed to flow freely adjacent the heat sink.

Also in such an embodiment, by providing on the one hand a frame structure and on the other hand a cover structure a modular assembly is obtained. Moreover, by using an upper cover with adequate dimensions, the frame structure can be adequately covered whilst still allowing a good operation of the heat sink.

Preferably, the cover structure comprises a lower cover configured for covering a lower portion of the frame structure, wherein the upper cover adjoins the lower cover along at least two opposite sides of the luminaire head. In this way, the upper and lower cover can adequately surround the frame structure and determine largely the look of the luminaire. Thus, the same frame structure can be combined with different cover structures if it is desirable to offer luminaire heads with a different look.

In an exemplary embodiment, the frame structure is a single piece and the heat sink is an integral part of the frame structure.

In another exemplary embodiment, the frame structure comprises a first frame part and a second frame part removably attached to the first frame part, and the heat sink is integrated in the second frame part. The upper cover may cover at least a portion of the first frame part, and preferably substantially the entire first frame part.

Preferably, the luminaire head assembly further comprises a driver configured for driving said at least one light source, said driver being attached to said frame structure, and more preferably to the first frame part thereof. For example, there may be provided a gear tray with a driver and the gear tray may be fixed to the frame structure. However, in other embodiments, the driver may be provided outside of the luminaire head.

According to a further aspect, there is provided a luminaire head assembly comprising a frame structure integrating a first fixation part, an optical block, a second fixation part, and a cover structure. The frame structure further comprising a frame part having a heat sink. The optical block comprises at least one light source and is attached to the frame structure opposite the heat sink. The second fixation part is configured to be attached to a base, such as a pole, and to cooperate with said first fixation part. The cover structure may be configured and arranged for covering at least a portion of the first fixation part and the frame part.

According to another aspect, there is provided a luminaire head assembly comprising a gear tray, a frame structure with a first fixation part, a second fixation part, and a cover structure. The gear tray comprises one or more electrical components such as a driver configured for driving said at least one light source and/or surge protection circuitry and/or a fuse. The frame structure comprises a first fixation part and a frame part configured to receive the gear tray. Preferably, the first fixation part and the frame part are integrated in one piece. The optical block comprises at least one light source and is attached to the frame structure. The second fixation part is configured to be attached to a base, such as a pole, and to cooperate with said first fixation part. The cover structure is configured and arranged for covering at least a portion of the first fixation part and the frame part.

Preferably, the first and second fixation part are configured such that the frame structure can be mounted in different positions with respect to the base. For example, the first fixation part could include a structure with a plurality of steps, wherein each step defines a different position of the frame structure relative to the second fixation part.

Preferably, the second fixation part comprises a tubular portion configured to receive a portion of a pole. In this way, the second fixation part can be easily attached to a pole, whereupon the frame structure may be fixed through the first fixation part thereof which can cooperate with the second fixation part.

Preferably, the first and second fixation part comprise a first and second pivot part, respectively, such that the frame structure can be mounted in different angular positions with respect to the base. In this way the optical block can be oriented in a suitable direction.

Preferably, the assembly further comprises a driver configured for driving the at least one light source, said driver being attached to the frame structure between the optical block and the first fixation part. Optionally, the driver may be part of a gear tray which is attached to the frame structure, e.g. in a frame opening of the frame structure as described above.

Preferably, the cover structure comprises a lower cover configured for covering a lower portion of the first fixation part and/or an upper cover, and more preferably the upper cover adjoins the lower cover along at least two opposite sides of the luminaire head.

According to another aspect there is provided a luminaire head assembly comprising a frame structure, an optical block, a gear tray and a cover structure. The frame structure comprises a first frame part and a second frame part, said second frame part having a heat sink. The optical block has at least one light source and is attached to said frame structure opposite the heat sink. The gear tray comprises one or more electrical components, such as a driver configured for driving said at least one light source and/or surge protection circuitry and/or a fuse. The cover structure is configured and arranged for covering at least a portion of the frame structure. The gear tray is attached to the first frame part and the second frame part is pivotable with respect to the first frame part.

By having a second frame part which carries the optical block, and which is pivotable with respect to the first frame part, the at least one light source can be oriented in a suitable manner. This may be combined with simple fixation means for fixing the first frame part to a base or with adjustable fixation means, e.g., as described above, so that two degrees of adjustment are possible.

Preferably, the cover structure comprises an upper cover configured for covering an upper portion of the first frame part and/or a lower cover configured for covering a lower portion of the first frame part. Optionally, the upper cover adjoins the lower cover along at least two opposite sides of the luminaire head.

The following preferred features may be used in combination with all aspects disclosed above.

Preferably, the cover structure is dimensioned such that air is allowed to flow freely adjacent the heat sink.

Preferably, the frame structure comprises metal, more preferably an aluminum material.

Preferably, the cover structure comprises a non-metal material, preferably a plastic material.

In an exemplary embodiment, the cover structure is provided with a hole in which a receptacle configured for a receiving a pluggable external module is arranged. Such receptable may be arranged in an upper cover or in a lower cover.

The pluggable external module may contain different control blocks and/or sensors, e.g. a light sensor for sensing the light level of ambient light to automatically control the one or more light sources of the optical block. For uniformity throughout the lighting industry, electrical receptacles for receiving such external modules are mostly made according to specific standards such as standards approved by American National Standards Institute, Inc. (ANSI). Such receptacles are electrically connected to various components of the assembly, and in particular to components of the gear tray. The receptacle has a connection interface located on an external side of the cover structure, so that an external module can be plugged into the receptacle to provide control for the lighting equipment. Preferably, the receptacle and the external control module fulfil the requirements of the ANSI C136.10-2017 standard or of the ANSI C136.41-2013 standard or of the Zhaga Interface Specification Standard (Book 18, Edition 1.0, July 2018, see https://www.zhagastandard.org/data/downloadables/1/0/8/1/book_18.pdf).

According to an exemplary embodiment, the receptacle may be implemented as described in PCT publication WO2017133793A1 in the name of the applicant, which is included herein by reference. Optionally, the receptacle may be configured and/or mounted as described in PCT publications WO2020212515 and/or WO2021001544A1 in the name of the applicant, which are included herein by reference.

In an exemplary embodiment, the cover structure is provided with a hole in which a sensor or human interface device is arranged. The one sensor may be e.g. selected from: an optical sensor such as a photodetector or an image sensor, a sound sensor, a radar such as a Doppler effect radar, a LIDAR, a humidity sensor, a pollution sensor, a temperature sensor, a motion sensor, an antenna, an RF sensor, a vibration sensor, a metering device (e.g. a metering device for measuring the power consumption of a component of an edge device, more in particular a metering device for measuring the power consumption of a driver of a luminaire), a malfunctioning sensor (e.g. a sensor for detecting the malfunctioning of a component of an edge device such as a current leakage detector for measuring current leaks in a driver of a luminaire), a measurement device for measuring a maintenance related parameter of a component of the edge device, an alarm device (e.g. a push button which a user can push in the event of an alarming situation).

Preferred embodiments relate to a luminaire head assembly for use in an outdoor luminaire. By outdoor luminaire, it is meant luminaires which are installed on roads, tunnels, industrial plants, stadiums, airports, harbors, rail stations, campuses, parks, cycle paths, pedestrian paths or in pedestrian zones, for example, and which can be used notably for the lighting of an outdoor area such as roads and residential areas in the public domain, private parking areas and access roads to private building infrastructures, etc.

In a particular embodiment, the optical block may comprise one or more optical elements, typically one or more lens elements and optionally one or more other optical element such as reflectors, backlights, prisms, collimators, diffusors, and the like. For example, there may be associated a backlight element with one or more lens elements or with each lens element. The one or more other optical elements may be formed integrally with the one or more lens elements, and e.g. integrally with a lens plate. In other embodiments, the one or more other optical elements may be mounted on the lens elements.

In the context of the invention, a lens element may include any transmissive optical element that focuses or disperses light by means of refraction. It may also include any one of the following: a reflective portion, a backlight portion, a prismatic portion, a collimator portion, a diffusor portion. For example, a lens element may have a lens portion with a concave or convex surface facing a light source, or more generally a lens portion with a flat or curved surface facing the light source, and optionally a collimator portion integrally formed with said lens portion, said collimator portion being configured for collimating light transmitted through said lens portion. Also, a lens element may be provided with a reflective portion or surface, referred to as a backlight element in the context of the invention, or with a diffusive portion.

A lens element may comprise a lens portion having an outer surface and an inner surface facing the associated light source. The outer surface may be a convex surface and the inner surface may be a concave or planar surface. Also, a lens element may comprise multiple lens portions adjoined in a discontinuous manner, wherein each lens portion may have a convex outer surface and a concave inner surface. Lens elements are not limited to rotation-symmetric lenses such as hemispherical lenses, or to ellipsoidal lenses having a major symmetry plane and a minor symmetry plane, although such rotation-symmetric lenses could be used. Alternatively, lenses with no symmetry plane or symmetry axis could be envisaged.

In a particular embodiment, one or more further optical elements may be further provided such as one or more light shielding structures complying with different glare classifications, e.g. the G classification defined according to the CIE115:2010 standard and the G* classification defined according to the EN13201-2 standard. The light shielding structures may be configured for reducing a solid angle of light beams of the light emitting elements by cutting off or reflecting light rays having a large incident angle, thereby reducing the light intensities at large angles and improving the G/G* classification of the luminaire system. The one or more light shielding structures may be mounted on any one of the optical elements, the optical plate or the substrate. Alternatively, the one or more light shielding structures may be integrally formed with any one of the optical elements or the optical plate. Examples of such shielding structures and similar optical elements are disclosed in patent specifications N2021671, WO2020249684A1, WO2021186058A1, N2025166, and WO2020058282A1, in the name of the applicant, which are included herein by reference.

Examples of suitable optical elements, and especially modular optical systems, are disclosed in PCT patent specifications WO2020074229A1, WO2020136197A1, WO2022023441A1 and in NL patent specification N2030243, all in the name of the applicant, which are included herein by reference. Also, side emitting LEDs in combination with suitable optics may be used, as disclosed for example in NL patent specification N2032294 in the name of the applicant, which is included herein by reference.

Furthermore, an optical element or optical plate may be movable and/or the control of the light elements may be selective. Examples of movable optics are disclosed in patent applications WO2019134875A1, WO2020136202A1, WO2020136200A1, WO2020136205A1, WO2020136203A1, WO2020136204A1, WO2020136197A1, and WO2020136196A1 in the name of the applicant, which are included herein by reference. Examples of selective control of light elements are disclosed in patent applications WO2019020366A1, WO2020165284A1, WO2020173836A1, and WO2021130275A1 in the name of the applicant, which are included herein by reference.

Other preferred embodiments are defined in the following clauses:
1. Luminaire head assembly comprising:
a frame structure (10) with a heat sink (15),
an optical block (40) with at least one light source, said optical block being attached to said frame structure opposite the heat sink,
a cover structure (30a, 30b, 30c) configured and arranged for covering at least a portion of the frame structure, said cover structure comprising an upper cover (30a) with a hole (31) dimensioned such that a portion of the heat sink is accessible through said hole and such that air is allowed to flow freely adjacent the heat sink.
2. Luminaire head assembly comprising:
a frame structure (10) with a heat sink,
an optical block (40) with at least one light source, said optical block being attached to said frame structure opposite the heat sink,
a cover structure (30a, 30b, 30c) configured and arranged for covering at least a portion of the frame structure, said cover structure comprising an upper cover (30a) with a width (Wc) which is larger than a width (Wf) of the frame structure covered by the upper cover and which is arranged and dimensioned such that a portion of the heat sink is not covered by the upper cover and such that air is allowed to flow freely adjacent the heat sink.
3. The luminaire head assembly of any one of the previous clauses, wherein the cover structure comprises a lower cover (30b) configured for covering a lower portion of the frame structure, and wherein the upper cover adjoins the lower cover along at least two opposite sides (35a, 35b; 36a, 36b) of the luminaire head.
4. The luminaire head assembly of any one of the previous clauses, wherein the heat sink is an integral part of the frame structure.
5. The luminaire head assembly of any one of the previous clauses, wherein the frame structure comprises a first frame part and a second frame part removably attached to the first frame part, wherein the heat sink is integrated in the second frame part, and wherein the upper cover covers at least a portion of the first frame part.
6. The luminaire head assembly of any one of the previous clauses, further comprising a driver (51) configured for driving said at least one light source, said driver being attached to said frame structure.
7. The luminaire head assembly of clause 5 and 6, wherein the driver is attached to the first frame part.
8. Luminaire head assembly comprising:
a frame structure (10) comprising a first fixation part (16) and a frame part (12) having a heat sink,
wherein the first fixation part and the frame part are preferable integrated in one piece,
an optical block (40) with at least one light source, said optical block being attached to said frame structure opposite the heat sink,
a second fixation part (60) configured to be attached to a base, such as a pole, and to cooperate with said first fixation part;
a cover structure (30a, 30b, 30c) configured and arranged for covering at least a portion of the first fixation part and the frame part.
9. Luminaire head assembly comprising:
a frame structure (10) comprising a first fixation part (16) and a frame part (11), wherein the first fixation part and the frame part are preferable integrated in one piece,
a gear tray (50) comprising one or more electrical components such as a driver configured for driving said at least one light source and/or surge protection circuitry and/or a fuse, said gear tray being attached to the frame part,
an optical block (40) with at least one light source, said optical block being attached to said frame structure,
a second fixation part (60) configured to be attached to a base, such as a pole, and to cooperate with said first fixation part;
a cover structure (30a, 30b, 30c) configured and arranged for covering at least a portion of the first fixation part and the frame part.
10. The luminaire head assembly of clause 8 or 9, wherein the first and second fixation part are configured such that the frame structure can be mounted in different positions with respect to the base.
11. The luminaire head assembly of any one of the clauses 8-10, wherein the first and second fixation part comprise a first and second pivot part, respectively, such that the frame structure (10) can be mounted in different angular positions with respect to the base.
12. The luminaire head assembly of clauses 8-11, further comprising a driver configured for driving said at least one light source, said driver being attached to said frame structure between the optical block and the first fixation part.
13. The luminaire head assembly of any one of the clauses 8-12, wherein the second fixation part comprises a tubular part configured to receive a portion of a pole.
14. The luminaire head assembly of any one of the clauses 8-13, wherein the cover structure comprises a lower cover configured for covering a lower portion of the first fixation part.
15. The luminaire head assembly of the previous clause, wherein the cover structure comprises an upper cover, and wherein the upper cover adjoins the lower cover along at least two opposite sides of the luminaire head.
16. Luminaire head assembly comprising:
a frame structure (10) comprising a first frame part (11) and a second frame part (12), said second frame part having a heat sink (15),
an optical block with at least one light source, said optical block being attached to said frame structure opposite the heat sink,
a gear tray (50) comprising one or more electrical components, such as a driver configured for driving said at least one light source and/or surge protection circuitry and/or a fuse,
a cover structure configured and arranged for covering at least a portion of the frame structure,
wherein the gear tray is attached to the first frame part and wherein the second frame part is pivotable with respect to the first frame part.
17. The luminaire head assembly of the previous clause, wherein the cover structure comprises an upper cover configured for covering an upper portion of the first frame part and/or a lower cover configured for covering a lower portion of the first frame part.
18. The luminaire head assembly of the previous clause, wherein the upper cover adjoins the lower cover along at least two opposite sides of the luminaire head.
19. The luminaire head assembly of any one of the clauses, wherein the cover structure is dimensioned such that air is allowed to flow freely adjacent the heat sink.
20. The luminaire head assembly of any one of the previous clauses, wherein the cover structure is provided with a hole in which a receptacle (70) configured for a receiving a pluggable control module (80) is arranged.
21. The luminaire head assembly of any one of the previous clauses, wherein the frame structure comprises metal, preferably an aluminum material.
22. The luminaire head assembly of any one of the previous clauses, wherein the cover structure comprises a non-metal material, preferably a plastic material.

### BRIEF DESCRIPTION OF THE FIGURES

Aspects of the present invention will now be described in more detail, with reference to the appended drawings showing exemplary embodiments. Like numbers refer to like features throughout the drawings.

FIG. 1 is an exploded perspective view of a luminaire head assembly according to an exemplary embodiment;

FIG. 2 is a perspective view of the luminaire head assembly of FIG. 1 in the assembled state, seen from above;

FIG. 3 is a perspective view of the luminaire head assembly of FIG. 1 in the assembled state, seen from below;

FIG. 4 is a cross-sectional view of a portion of the luminaire head assembly of FIG. 1;

FIG. 5 is an exploded bottom view of a luminaire head assembly according to an exemplary embodiment;

FIG. 6A is an exploded bottom view of a luminaire head assembly according to an exemplary embodiment;

FIG. 6B is a side view of the exemplary embodiment of FIG. 2A.

FIG. 7 is a cross-sectional view of a portion of a luminaire head assembly according to a variant;

FIG. 8 is a perspective view of a lower cover with integrated sensing means;

FIG. 9 is a bottom view of another exemplary embodiment of a luminaire head assembly;

FIG. 10 is a perspective view of an exemplary embodiment of the frame structure; and

FIG. 11 shows various images of an exemplary embodiment;

FIG. 12 shows perspective views of the fixation parts in one exemplary embodiment.

### DESCRIPTION OF EMBODIMENTS

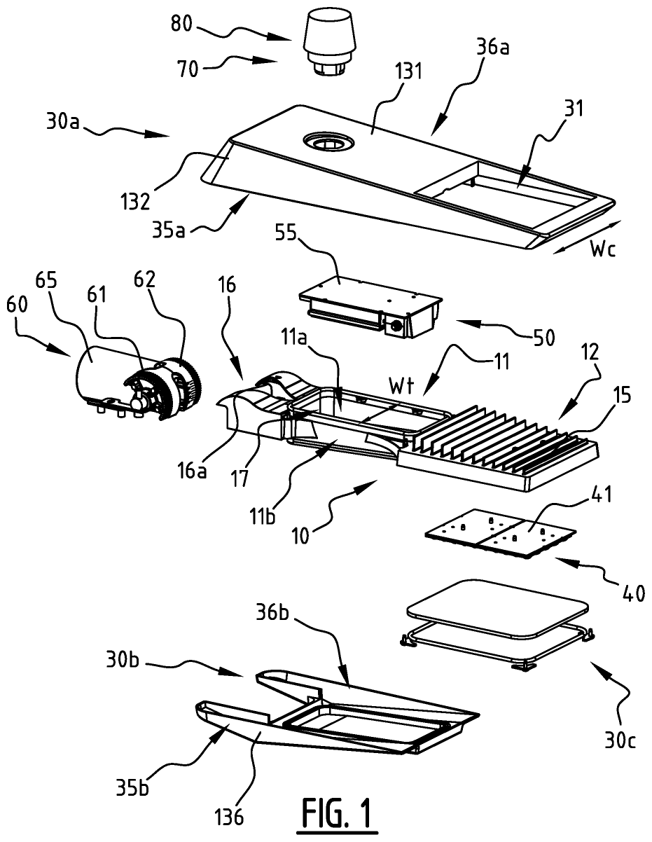

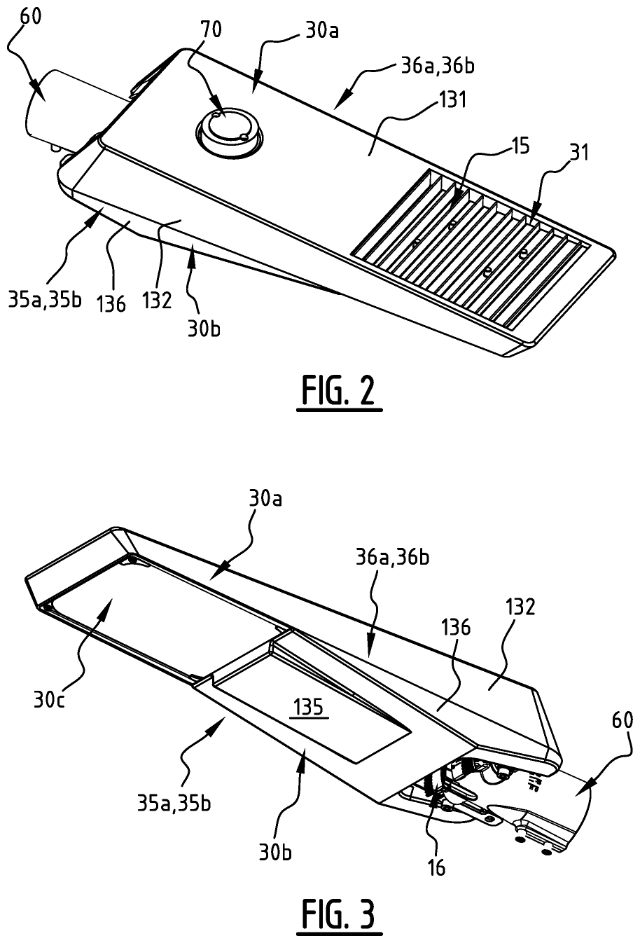

FIGS. 1-4 illustrate schematically a luminaire head assembly comprising a frame structure 10, an optical block 40, a gear tray 50, a fixation part 60 and a cover structure 30a, 30b, 30c. A similar luminaire head is shown in FIG. 11.

The frame structure 10 is provided with a heat sink 15 which is here an integral part of the frame structure. The frame structure comprises a first frame part 11 and a second frame part 12 which integrates the heat sink 15. The first frame part 11 has a frame opening 11a extending between an upper and a lower side of the frame structure 10 and configured to receive the gear tray 50.

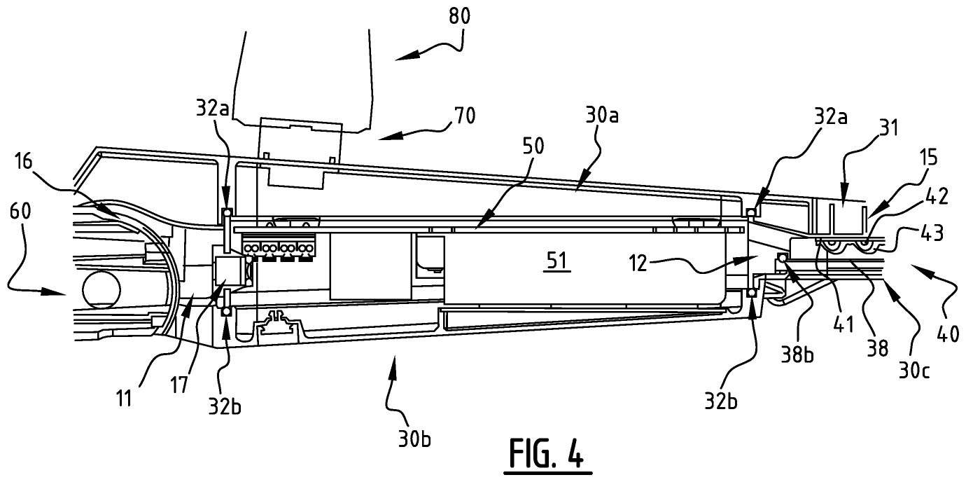

The optical block 40 comprises a support 41 on which one or more light sources 42, typically LEDs, are arranged, see FIG. 4. Optionally, one or more optical elements 43 may be arranged over the one or more light sources 42. The optical block 40 is attached to the frame structure 10 opposite the heat sink 15.

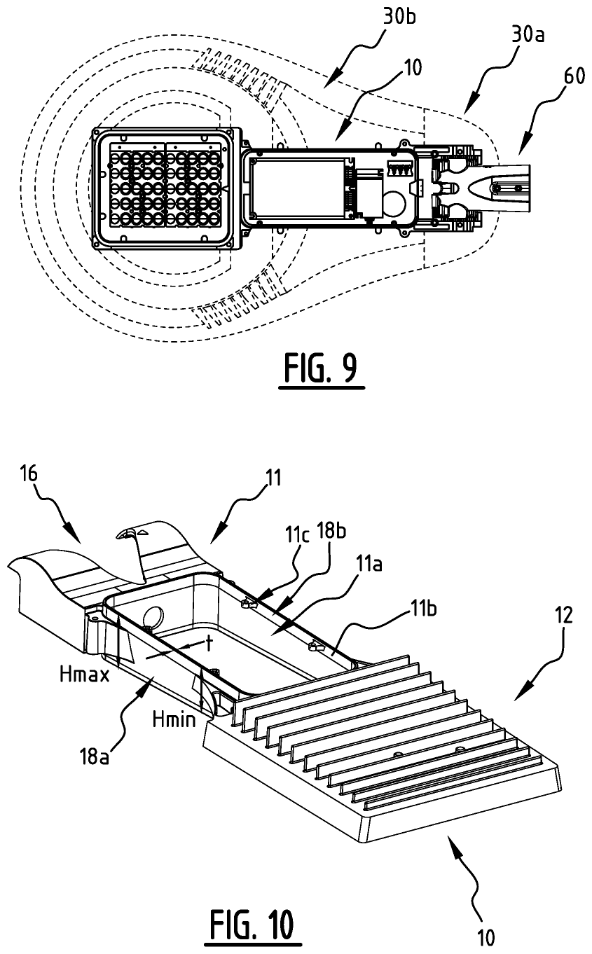

The cover structure 30a, 30b, 30c is configured and arranged for covering at least a portion of the frame structure 10. The cover structure may comprise an upper cover 30a and a lower cover 30b. The upper cover 30a is configured for covering an upper portion of the frame structure 10, and preferably substantially the entire first frame part 11. The upper cover may be provided with a hole 31 dimensioned such that a portion of the heat sink 15 is accessible through said hole 31 and such that air is allowed to flow freely adjacent the heat sink 15. The lower cover 30b is configured for covering a lower portion of the frame structure 10. The upper cover 30a may adjoin the lower cover 30b along at least two opposite sides 35a, 35b; 36a, 36b of the luminaire head. In this way the cover structure can at least partially enclose the frame structure and provide the luminaire with any desired look. Indeed, the cover structure 30a, 30b may have a substantially rectangular shape, seen from below or above as in FIG. 1, but could also have a rounded shape as illustrated in FIG. 9. More generally, the cover structure 30a, 30b may be given any suitable or desired shape. A fixation means 85, such as a clip, may be provided to attach the upper cover to the lower cover, see FIG. 11.

The gear tray 50 may comprise one or more electrical components such as a driver 51 configured for driving the at least one light source 42 and/or surge protection circuitry and/or a fuse. Preferably, the gear tray 50 comprises a plate 55 on which the one or more electrical components are mounted. The gear tray 50 is intended to be fixed in the hole 11a in the first frame part 11. Preferably the hole 11a is delimited by a circumferential wall 11b. The circumferential wall 11b may be provided at an inner side thereof with fixation elements 11c such as inwardly protruding lugs to which the gear tray 50 may be fixed. Optionally, the first frame part 11 may be provided with a cable gland 17 for a power cable (not shown) to be connected to the gear tray 50. Such cable gland 17 may be provided in the circumferential wall 11b. Optionally the driver 51 may be provided with one or more pluggable modules to enhance the functionalities of the driver, as described in WO2017220690A1 or WO2020064864 in the name of the applicant which are included herein by reference.

The upper cover 30a may be provided with a receptacle 70 in which a pluggable control module 80 can be fitted.

The upper cover 30a may have a width Wc which is larger than a width Wf of the frame part of the frame structure 10 covered by the upper cover 30a, here frame part 11. The upper cover 30a and the lower cover 30b may be configured for covering the frame opening 11a from above and from below, respectively. As shown in FIG. 4 an upper seal 32a may be arranged between the upper cover 30a and the frame structure 10 around the frame opening 11a, and a lower seal 32b may be arranged between the lower cover 30b and the frame structure 10 around the frame opening 11a. The upper cover 30a may adjoin the lower cover 30b along at least two opposite sides 35a, 35b; 36a, 36b of the luminaire head. More in particular, the upper cover 30a may have a top wall 131 and an upper peripheral wall 132, and the lower cover 30b may have a bottom wall 135 and a lower peripheral wall 136, and a lower edge portion of the upper peripheral wall 132 may be adjacent an upper edge portion of the lower peripheral wall 136.

The cover structure may further comprise a second lower cover 30c comprising a cover frame 37 and transparent or translucent protector 38. This second lower cover 30c covers the optical block 40. A seal 38b may be arranged between the frame structure 10 and the protector 38, see FIG. 4.

The frame structure 10 comprises a first fixation part 16 configured to cooperate with a second fixation part 60. The second fixation part 60 is configured to be attached to a base, such as a pole, and to cooperate with said first fixation part 16. The cover structure 30a, 30b, 30c may then be configured and arranged for covering at least a portion of the first fixation part 16. In the illustrated embodiment the upper cover 30a extends over the first fixation part 16 and a portion of the second fixation part 60. Preferably, the first and second fixation part 16, 60 may be configured such that the frame structure 10 can be mounted in different positions with respect to the base. More preferably, as illustrated, the first and second fixation part 16, 60 may comprise a first and second pivot part, respectively, such that the frame structure 10 can be mounted in different angular positions with respect to the base.

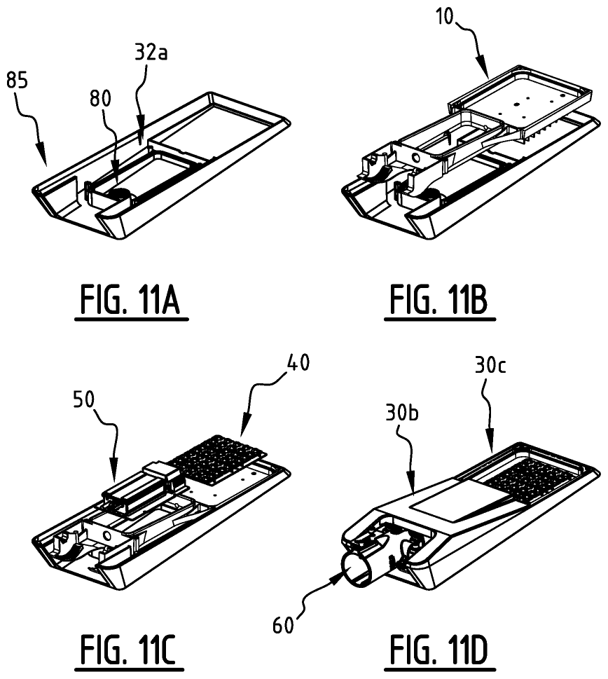

The frame is shown in more detail in FIG. 10. The frame structure 100 comprises a first and second wing 18a, 18b extending from the fixation end 16 at a first and second longitudinal side of the frame opening. The first and second wing 18a, 18b may have a minimum height Hmin and a minimum thickness t, wherein 5<Hmin/t<60, preferably 6<Hmin/t<40, more preferably 7<Hmin/t<35. The minimum height may be e.g. between 15 mm and 60 mm and the thickness t may be between 1.5 mm and 4 mm.

In an exemplary embodiment, the first and second wing have an average height Hav and an average thickness tav, seen along a side adjacent the frame opening, wherein 5<Hav/tav<60, preferably 6<Hav/tav<40, more preferably 7<Hav/tav<35. The average height may be e.g. between 30 mm and 60 mm and the average thickness tav may be between 1.5 mm and 4 mm.

In an exemplary embodiment, the frame part delimiting the frame opening 11a may comprise a peripheral wall 11b delimiting the frame opening. Optionally, an inner side of the peripheral wall may be provided with fixation means 11c facilitating the mounting of the gear tray in the frame opening 11a. Such peripheral wall 11a may have a maximum height which is larger than 20 mm, preferably larger than 30 mm, more preferably larger than 40 mm. In this way, the frame part is sufficiently rigid and provides enough room for the gear tray. Also, the relatively large height results in an improved moment of inertia.

In the illustrated embodiment, the first and second fixation parts are similar to the second and first joint member 200, 100, respectively, disclosed in PCT publication WO2020144191A1 in the name of the applicant, which is included herein by reference.

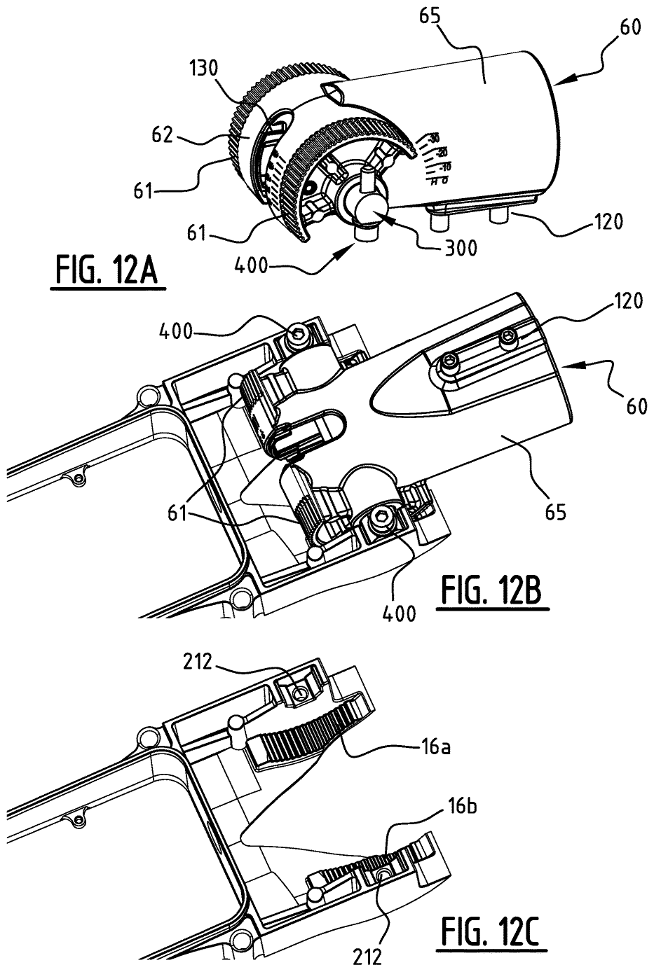

As illustrated in further detail in FIG. 12A, the second fixation part 60 comprises a tubular part 65 for receiving a pole portion and an outer cylindrical surface section 62 provided with a first plurality of interengaging surfaces 61. The first fixation part 16, illustrated in FIG. 12C, comprises an inner cylindrical surface provided with a second plurality of interengaging surfaces 16a and 16b configured to interengage the first plurality of interengaging surfaces 61, as illustrated in FIG. 12B.

In the embodiment illustrated in FIGS. 12A-C, the first fixation part 16 and the second fixation part 60 are fixed with the help of a shaft 300, and a fixation means 400. The tubular part 65 may have an inner diameter larger than an outer diameter of the luminaire pole portion to be mounted over it, or may have an outer diameter smaller than an inner diameter of the luminaire pole portion to be mounted within it. The second fixation part 60 may be fixed to the base support via a mounting structure 120, a pair of holes allowing a pair of bolts passing through a corresponding pair of holes within a base support portion to fix together the second fixation part 60 and the base support. A cavity within the second fixation part 60 may allow the passage from the base support to the luminaire head of connecting means, e.g. electrical connection, data transmitting wiring, antenna connection, and the like. The second fixation part 60 may comprise an opening 130 configured for enabling a passage of the connecting means.

The second fixation part 60 is provided with an outer cylindrical surface section 62, which may be shaped as a complete cylindrical surface or, as illustrated in FIG. 12A, a partial cylindrical surface. The outer cylindrical surface section 62 is provided with a first plurality of inter-engaging surfaces 61. The inter-engaging surfaces 61 may be defined as a plurality of surfaces having different angular positioning with respect to each other and/or predetermined roughness, and conceived to cooperate with another corresponding plurality of inter-engaging surfaces, i.e. the plurality of inter-engaging surfaces 16a and 16b of the first fixation part 16. The first and second pluralities of inter-engaging surfaces 61, 16a, 16b may be inter-engaging teeth as depicted in FIGS. 12A-C, inter-engaging conical elements perpendicular to the cylindrical surfaces, rough surfaces configured for producing a predetermined friction when engaged, three-dimensional elements, and the like. Depending on the characteristics of the inter-engaging surfaces 61, the obtained angular adjustment, for example in steps, of the first plurality of inter-engaging surfaces with respect to the second has a different precision.

The first plurality of inter-engaging surfaces 61 may be made of plastic or metal, preferably steel or aluminum, and may be mounted or integrally formed with the second fixation part 60.

The second fixation part 60 comprises opposing bearings that extend away from the tubular portion 65 along a direction of an axis of the cylindrical surface section 62 and that comprise an inner tubular cavity connected to an inner cavity of the second fixation means 60. First and second shaft portions of a shaft 300, which may be comprised by a single shaft or by two independent shafts, extend through the pair of axially aligned bearings. The first and second shaft portions may comprise at least one landing, configured to cooperate with a pair of receiving surfaces 212.

As mentioned above, an inner cylindrical surface of the first fixation part 16 is provided with the second plurality of inter-engaging surfaces 16a, 16b, a plurality of inter-engaging teeth in FIGS. 12A-C, configured for complementing the first plurality of inter-engaging surfaces 61 of the second fixation part 60. The second plurality of inter-engaging surfaces may be made of plastic or metal, and be integrally formed or mounted to the inner cylindrical surface of the first fixation part 16 The second plurality of inter-engaging surfaces 16a, 16b may be made in a similar or different material than the first plurality of inter-engaging surfaces 61.

The fixation means 400 is configured for fixing the first and second shaft portions of the shaft 300 to the first fixation part 16. In the exemplary embodiment of FIGS. 12, the fixation means 400 comprises a pair of bolts. The fixation means 400 is configured for enabling the engagement of at least a portion of the first plurality of inter-engaging surfaces 61 with at least a portion of the second plurality of inter-engaging surfaces 16a, 16b, and for enabling the release of said engagement such that a rotation movement of the first fixation part 16 relative to the second fixation part 60 is enabled with respect to the pivot axis defined by the shaft 300. As illustrated in FIG. 12A, the second fixation part 60 may further comprise an angular indicator.

The first and second fixation parts 16, 60 may have any of the other features of the second and first joint member 200, 100, respectively, disclosed in PCT publication WO2020144191A1.

In other embodiments (not illustrated), the second fixation part 60 could comprise a simple U-shaped part in which a pole part can be received, and the frame structure would then comprise a means configured for cooperating with the U-shaped second fixation part. Such fixation system is disclosed in PCT publication WO2019015976A1 in the name of the applicant, which is included herein by reference, see in particular fastener means 140 and 41 which would form the second fixation part and a portion of the plate 110 with two holes or the fastener block 40, e.g. a fastener block with a stepped surface, which would form the first fixation part, respectively.

In another embodiment (not illustrated), the first and second fixation parts are similar to the second and first element 200, 100, respectively, disclosed in PCT publication WO2022069368A1 in the name of the applicant, which is included herein by reference.

In yet another embodiment (not illustrated), the frame structure may comprise a tubular portion in which a portion of the pole may be arranged. A frame structure with a tubular portion is disclosed in PCT publication WO2019197489A1 in the name of the applicant, which is included herein by reference.

Preferably, the frame structure 10 is made of metal, more preferably an aluminum material. Preferably, the cover structure is made of a non-metal material, more preferably a plastic material.

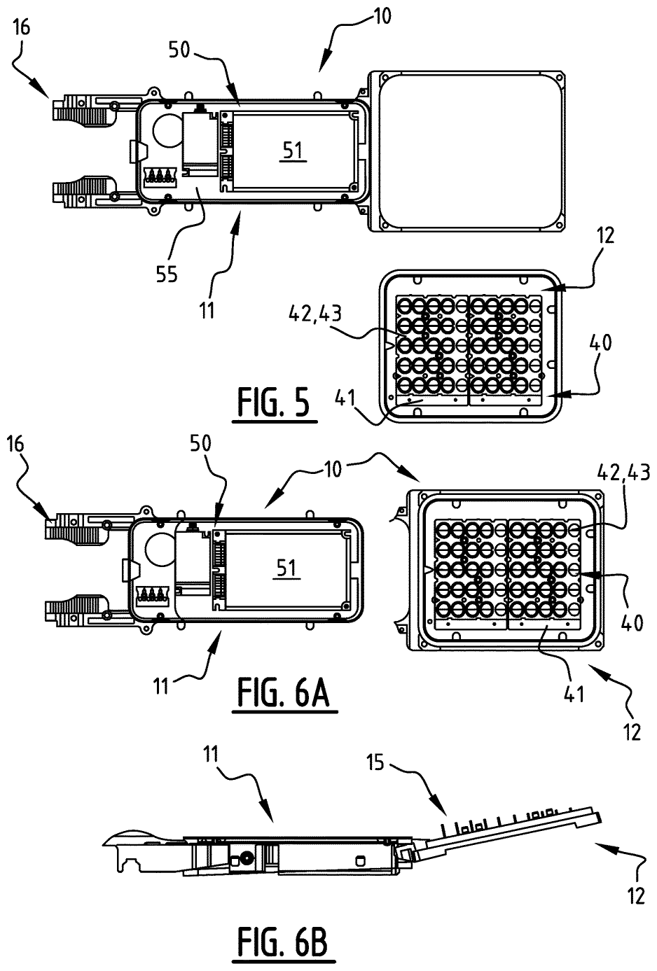

FIG. 5 illustrates another exemplary embodiment of a luminaire head assembly for which the same or similar elements have been indicated with the same reference numerals. In this embodiment the second frame part 12 integrates the heat sink and this second frame part 12 can be removably attached to the first frame part 11. The first frame part 11 is provided at a first end with a fixation part 16 and at a second end opposite said first end with a peripheral frame 19 in which the second frame part 12 can be arranged. The optical block 40 is mounted on the second frame part 12 opposite the heat sink (not visible in FIG. 5), such that the support 41 carrying the light sources 42 is in contact with the second frame part 12.

FIGS. 6A and 6B illustrate another embodiment of a luminaire head assembly for which the same or similar elements have been indicated with the same reference numerals. In this embodiment the second frame part 12 integrates the heat sink 15 and this second frame part 12 is pivotably attached to the first frame part 11, such that the second frame part 12 can be put in different angular positions with respect to the first frame part 11. The second frame part 12 may be one integral part or may be composed of a peripheral frame 19 in which the heat sink 15 is arranged as in FIG. 5. The gear tray 50 is attached to the first frame part 11.

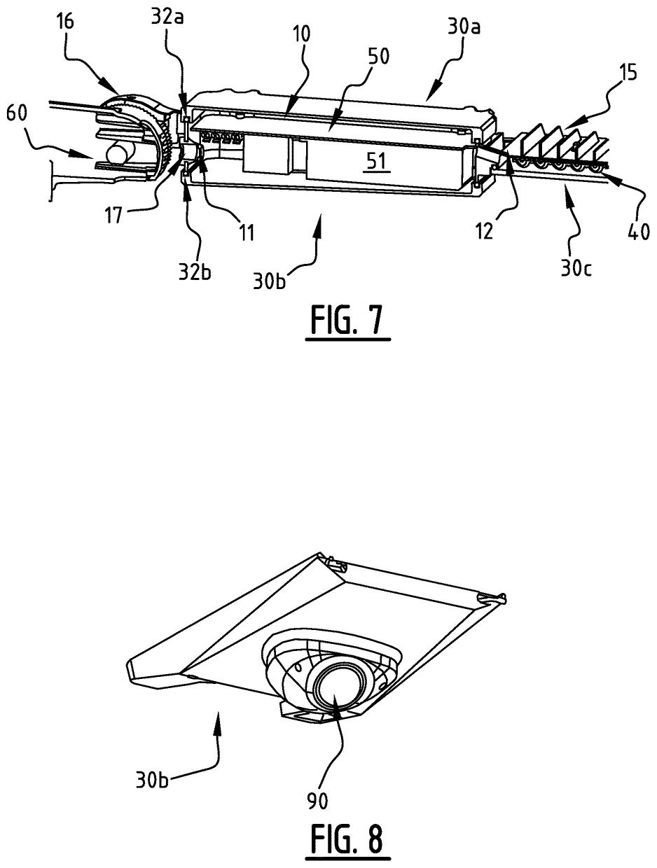

FIG. 7 illustrates another exemplary embodiment of a luminaire head assembly for which the same or similar elements have been indicated with the same reference numerals. The cover structure comprises an upper cover 30a configured for covering an upper portion of the first frame part 11 and a lower cover 30b configured for covering a lower portion of the first frame part 11. The upper cover 30a is arranged and dimensioned such that a portion of the heat sink 15 is not covered by the upper cover 30a and such that air is allowed to flow freely adjacent the heat sink. Preferably, the upper cover 30a adjoins the lower cover 30b along at least two opposite sides of the luminaire head (not shown, but this may be similar as in the embodiment of FIGS. 1-4).

FIG. 8 illustrates a variant of the lower cover 30b. As illustrated a sensor device 90, such as a camera, may be integrated in the lower cover 30b. More generally any type of sensor or human interface device may be integrated in the upper cover 30a or in the lower cover 30b. In yet other embodiments a sensor may be arranged on the frame structure 10, wherein optionally the cover structure extends over the sensor.

Whilst the principles of the invention have been set out above in connection with specific embodiments, it is to be understood that this description is merely made by way of example and not as a limitation of the scope of protection which is determined by the appended claims.

1. Luminaire head assembly comprising:
a frame structure with a heat sink,
an optical block with at least one light source, said optical block being attached to said frame structure opposite the heat sink,
a gear tray comprising one or more electrical components such as a driver configured for driving said at least one light source and/or surge protection circuitry and/or a fuse,
a cover structure configured and arranged for covering at least a portion of the frame structure,
said frame structure comprising a frame part with a frame opening extending between an upper and a lower side of the frame structure and configured to receive the gear tray.

2. The luminaire head assembly of claim 1, wherein the cover structure is configured for covering the upper and/or lower side of the frame opening.

3. The luminaire head of claim 1;
wherein the cover structure comprises an upper cover and a lower cover configured for covering the frame opening from above and from below, respectively;
wherein preferably an upper seal is arranged between the upper cover and the frame structure around the frame opening, and wherein a lower seal is arranged between the lower cover and the frame structure around the frame opening.

4. (canceled)

5. The luminaire head assembly of claim 3, wherein the upper cover adjoins the lower cover along at least two opposite sides of the luminaire head.

6. The luminaire head assembly of claim 1, wherein the frame structure has a fixation end configured to be fixed to a base, and the frame opening is located between the fixation end and the optical block.

7. The luminaire head assembly of claim 6;
wherein the frame structure comprises a first and second wing extending from the fixation end at a first and second longitudinal side of the frame opening,
wherein preferably the first and second wing have a minimum height Hmin and a minimum thickness t, wherein 5<Hmin/t<60, preferably 6<Hmin/t<40, more preferably 7<Hmin/t<35.

8. (canceled)

9. The luminaire head assembly of claim 1:
wherein the frame part comprises a peripheral wall delimiting the frame opening, said peripheral wall having a maximum height Hmax, said height Hmax being larger than 20 mm, preferably larger than 30 mm, more preferably larger than 40 mm; and/or
wherein the frame structure comprises a second frame part, optionally removably attached to the frame part with the frame opening, wherein the heat sink is integrated in the second frame part.

10. (canceled)

11. The luminaire head assembly of claim 1:
wherein the frame structure comprises a second frame part, optionally removably attached to the frame part with the frame opening, wherein the heat sink is integrated in the second frame part, and
wherein the second frame part is pivotable with respect to the frame part with the frame opening.

12. The luminaire head assembly of claim 1:
wherein the frame structure comprises metal, preferably an aluminum material; and/or
wherein the cover structure comprises a non-metal material, preferably a plastic material; and/or
wherein the gear tray comprises a plate-like element on which the one or more electrical components are arranged.

13-14. (canceled)

15. The luminaire head assembly of claim 1, wherein the cover structure is dimensioned such that air is allowed to flow freely adjacent the heat sink.

16. The luminaire head assembly of claim 1, wherein the cover structure comprises an upper cover with a hole dimensioned such that a portion of the heat sink is accessible through said hole and such that air is allowed to flow freely adjacent the heat sink.

17. The luminaire head assembly of claim 1:
wherein the cover structure is arranged and dimensioned such that a portion of the heat sink is not covered by the upper cover and such that air is allowed to flow freely adjacent the heat sink; and/or
wherein the cover structure comprises an upper cover with a width which is larger than a width of the frame structure covered by the upper cover; and/or
wherein the frame structure comprises a tubular fixation part as an integral part of the frame structure.

18. (canceled)

19. The luminaire head assembly of claim 1;
wherein the frame structure comprises a first fixation part, said first fixation part being preferably an integral part of the frame structure, said assembly further comprising a second fixation part configured to be attached to a base, such as a pole, and to cooperate with said first fixation part;
wherein preferably the cover structure is configured and arranged for a covering at least a portion of the first fixation part.

20. (canceled)

21. The luminaire head assembly of claim 19:
wherein the first and second fixation part are configured such that the frame structure can be mounted in different positions with respect to the base, preferably different angular positions with respect to the base; and/or
wherein the first and second fixation part comprise a first and second pivot part, respectively, such that the frame structure can be mounted in different angular positions with respect to the base; and/or
wherein the gear tray is attached to the frame structure between the optical block and the first fixation part.

22-23. (canceled)

24. The luminaire head assembly of claim 19:
wherein the second fixation part comprises a tubular part configured to receive a portion of a pole; or
wherein the second fixation part comprises a U-shaped part configured to receive a portion of a pole.

25. (canceled)

26. The luminaire head assembly of claim 19:
wherein the second fixation part is separate from the cover structure; and/or
wherein the cover structure comprises a lower cover configured for covering a lower portion of the first fixation part.

27-28. (canceled)

29. The luminaire head assembly of claim 1, wherein the heat sink is an integral part of the frame structure.

30. The luminaire head assembly of claim 1:
wherein the cover structure is provided with a hole in which a receptacle configured for a receiving a pluggable control module is arranged; and/or
wherein the cover structure is provided with a hole in which a sensor or human interface device is arranged.

31. (canceled)

32. Luminaire head assembly comprising:
a frame structure with a heat sink,
an optical block with at least one light source, said optical block being attached to said frame structure opposite the heat sink; and
a cover structure configured and arranged for covering at least a portion of the frame structure, said cover structure comprising an upper cover with a hole dimensioned such that a portion of the heat sink is accessible through said hole and such that air is allowed to flow freely adjacent the heat sink.

33. Luminaire head assembly comprising:
a frame structure comprising a first frame part and a second frame part, said second frame part having a heat sink,
an optical block with at least one light source, said optical block being attached to said frame structure opposite the heat sink,
a gear tray comprising one or more electrical components, such as a driver configured for driving said at least one light source and/or surge protection circuitry and/or a fuse,
a cover structure configured and arranged for covering at least a portion of the frame structure,
wherein the gear tray is attached to the first frame part and wherein the second frame part is pivotable with respect to the first frame part.
